(19) United States
(12) Patent Application Publication
(10) Pub. No.: US 2013/0054903 A1
(43) Pub. Date: Feb. 28, 2013

(54) MEMORY DEVICE AND WRITING METHOD THEREOF

(71) Applicant: Chin-Long WANG, Hualien County (TW)

(72) Inventor: Chin-Long WANG, Hualien County (TW)

(73) Assignee: NOVATEK MICROELECTRONICS CORP., Hsinchu (TW)

(21) Appl. No.: 13/537,673

(22) Filed: Jun. 29, 2012

(30) Foreign Application Priority Data
Aug. 24, 2011 (TW) 100130383

(51) Int. Cl. G06F 12/00

(52) U.S. Cl. 711/154; 711/E12.001

(57) ABSTRACT

A memory device including a data storing unit and a management unit is provided. The data storing unit includes a plurality of blocks each including a plurality of pages. The management unit identifies a page from the pages according to management information and writes a page data to the identified page according to management information. The management information at least comprises a block number and a page number.

This application claims the benefit of Taiwan application Serial No. 100130383, filed Aug. 24, 2011, the subject matter of which is incorporated herein by reference.

### BACKGROUND OF THE INVENTION

1. Field of the Invention

The invention relates in general to a memory, and more particularly to a memory device and a writing method thereof.

2. Description of the Related Art

A common NAND flash memory as a type of flash memories includes a single-level cell (SLC) flash memory, a multi-level cell (MLC) flash memory and a triple-level cell (TLC) flash memory. Data in a flash memory is erased in a unit of blocks. A flash memory comprises a plurality of blocks each comprising a plurality of pages. In a conventional flash memory, a writing process to the pages needs to be sequentially performed in an order from a low page number to a high page number.

In a data update mechanism of a flash memory, when writing data to a specific page is desired, it should be first determined whether the page already contains data. The desired data is directly written to the page if the page is blank. In contrast, if the page already contains data, another blank block has to be used for the data update because a direct data overwrite cannot be adopted.

However, when updating data in a conventional flash memory, it is necessary that data for all pages in a same block be first copied to a new block and the prior data then be erased. Such process is not only time consuming but also reduces a lifespan of the flash memory.

### SUMMARY OF THE INVENTION

The invention is directed to a memory device and a writing method thereof.

According to an aspect of the present invention, a memory device comprising a data storing unit and a management unit is provided. The data storing unit comprises a plurality of blocks each comprising a plurality of pages. The management unit identifies a page according to management information and writes a page data to the page according to the management information. The management information at least comprises a block number and a page number.

According to another aspect of the present invention, a writing method of a memory device is provided. The method comprises identifying a page in a block of a data storing unit according to management information, and writing a page data to the page according to management information.

According to another aspect of the present invention, a memory device comprising a data storing unit and a management unit is provided. The data storing unit comprises a plurality of physical blocks each comprising a plurality of pages. The management unit writes a first page data to a page in a first physical block of the data storing unit, and writes a second page data to a page in a second physical block of the data storing unit. The first page data and the second page data correspond to a same logical block number.

According to yet another aspect of the present invention, a writing method for a memory device is provided. The method comprises receiving a first page data and a second page data corresponding to a same logical block, writing the first data to a page in a first physical block of a data storing unit, and writing the second data to a page in a second physical block of the data storing unit.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a memory device according to an embodiment of the present invention.

FIG. 2 is a schematic diagram before updating data.

FIG. 3 is a schematic diagram after updating data.

### DETAILED DESCRIPTION OF THE INVENTION

A memory device and a writing method thereof are provided according to an embodiment of the present invention. The memory device comprises a data storing unit and a management unit. The data storing unit comprises a plurality of blocks each comprising a plurality of pages. The management unit identifies a page according to management information, and writes a page data to the page according to the management information.

The writing method of a memory device comprises identifying a page in a block of a data storing unit according to the management information, and writing a page data to the page according to the management information.

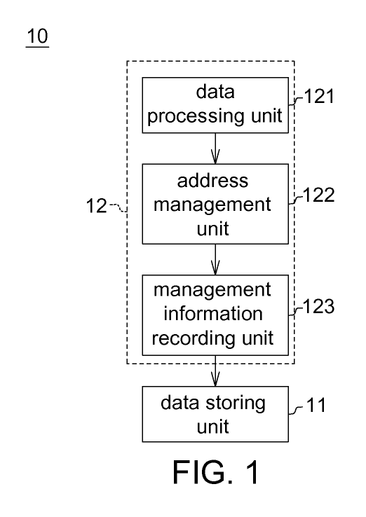

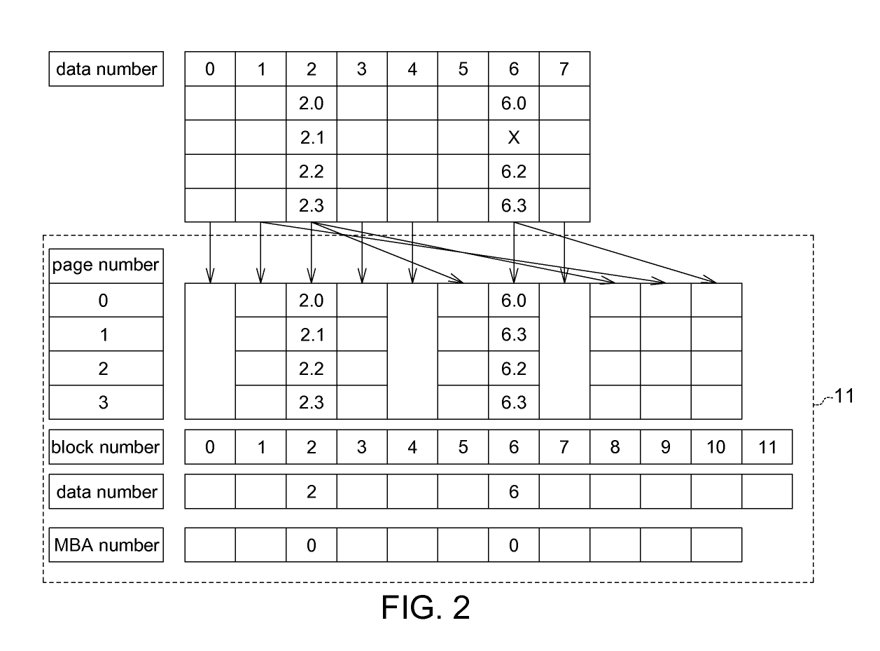

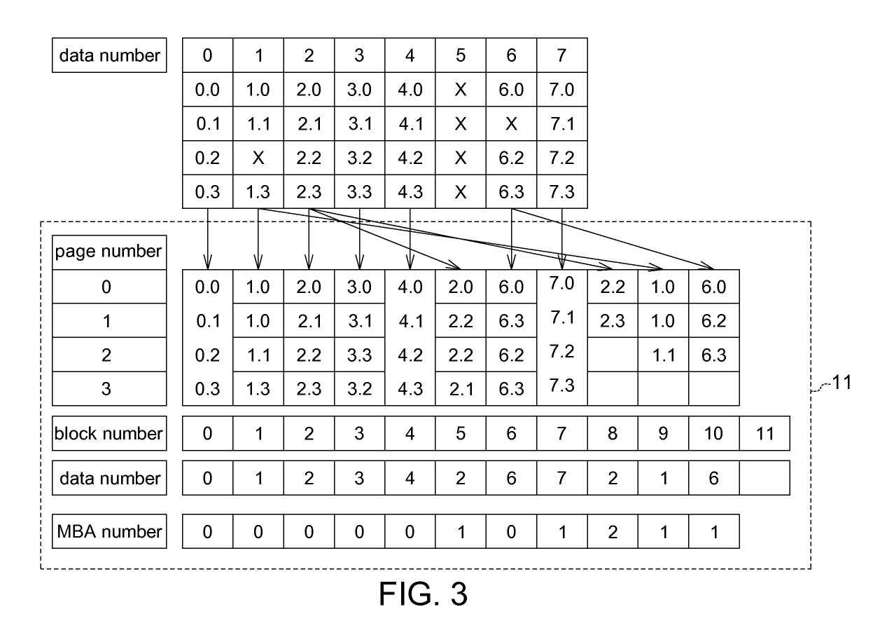

The description below shall be given with reference to FIGS. 1, 2 and 3. FIG. 1 shows a schematic diagram of a memory device according to an embodiment of the present invention; FIG. 2 shows a schematic diagram before updating data; FIG. 3 shows a schematic diagram after updating data. A memory device 10 comprises a data storing unit 11 and a management unit 12. For example, the memory device 10 is a non-volatile memory, e.g., a flash memory in an embodiment. The management unit 12 writes data to the data storing unit 11 according to management information. The management information includes such as a block number and a page number. Preferably, the management information may include a multi-block address (MBA) number. For example, the data storing unit 11 is a NAND memory device, e.g., an SLC memory device, an MLC memory device or a TLC memory device.

For example, the management unit 12 comprises an address management unit 122 and a management information recording unit 123. Apart from the address management unit 122 and the management information recording unit 123, the management unit 12 may further comprise a data processing unit 121. For illustrative purposes, the management unit 12 comprising the data processing unit 121, the address management unit 122 and the management information recording unit 123 in FIG. 1 is taken as an example. The data processing unit 121 divides original data to be written to the data storing unit 11 into block data or page data. The address management unit 122 provides a block number or a page number corresponding to the block data or the page data. The management information recording unit 123 records the management information to the memory device, e.g., to a spare area in the memory device or other external memories.

The management unit 12 determines different writing approaches according to different sizes of the data to be written. When the data to be written has a length of one block, the management unit 12 writes the data to the data storing unit 11 according to a corresponding approach specified by the management information. For example, for data with a data number 0 having a length of one block, the management unit 12 writes the data corresponding to the data number 0 to a block 0 according to the management information. Similarly, for data with data numbers 4 and 7 respectively having a length of one block, the management unit 12 respectively writes the data corresponding to the data numbers 4 and 7 to blocks with block numbers 4 and 7. Thus, such data allocation can be represented by a small amount of memories while a data access speed is increased.

When the data to be written has a length smaller than one block, the management unit 12 writes the data to the data storing unit 11 according to a corresponding approach specified by the management information. For example, data with a data number 1 has a length smaller than a one block, and comprises a page data 1.0, a page data 1.1 and a page data 1.3. The management unit 12 identifies a corresponding page number 3 in a block number 1 according to the management information, and writes the page data 1.3 to the corresponding page number 3 in the block number 1 according to the management information. The management unit 12 identifies a corresponding page number 0 in a block number 9 according to the management information, and writes the page data 1.0 to the corresponding page number 0 in the block number 9 according to the management information. The management unit 12 identifies a corresponding page number 1 in the block number 9 according to the management information, and writes the page data 1.0 to the corresponding page number 1 in the block number 9 according to the management information.

It should be noted that, one important feature of the embodiment is that the page data corresponding to a same data number may be stored in different blocks, i.e., MBA addressing. Taking the data number 1 for example, the data with the data number 1 is stored in the block number 1 and the block number 9, which means that a block depth of the data with the data number 1 is 2. The block depth represents the quantity of blocks occupied by data of a data number. A logical block number and a physical block number are a block number respectively perceived by an operating system and a memory device. Therefore, the logical block number may be regarded as the data number, and the physical block number may be regarded as the block number. In this embodiment, a relationship between the logical block number and the physical block number is flexibly adjusted from one-to-one to one-to-many through MBA. Due to the one-to-many relationship between the logical block number and the physical block number, excessively frequent exchange of internal data can be prevented to increase the storage efficiency as well as the lifespan of the memory device.

A size of the MBA number may be utilized to further confirm data duration validity. For example, the MBA number of the block number 9 is 1 and the MBA number of the block 1 is 0, which indicates the data in the block number 0 is older than the data in the block number 9 in the time frame. Hence, although prior data corresponding to the data number 1 is stored in the page numbers 0 to 2 in the block number 1 and the page number 0 in the block number 9, after updating data, the data stored in the page numbers 0 to 2 in the block number 1 and the page number 0 in the block number 9 shall lose the duration validity and be regarded as expired, invalid data. After confirming that the data is invalid, the management unit 12 retrieves the data for further management.

For example, the data with a data number 2 comprises a page data 2.0, a page data 2.1, a page data 2.2 and a page data 2.3. The management unit 12 identifies a corresponding page number 0 in the block number 5 according to the management information, and writes the page data 2.0 to the corresponding page number 0 in the block number 5 according to the management information. The management unit 12 identifies a corresponding page number 1 in the block number 5 according to the management information, and writes the page data 2.2 to the corresponding page number 1 in the block number 5 according to the management information. The management unit 12 identifies a corresponding page number 2 in the block number 5 according to the management information, and writes the page data 2.2 to the corresponding page number 2 in the block number 5 according to the management information. The management unit 12 identifies a corresponding page number 3 in the block number 5 according to the management information, and writes the page data 2.1 to the corresponding page number 3 in the block number 5 according to the management information. The management unit 12 identifies a corresponding page number 0 in the block number 8 according to the management information, and writes the page data 2.2 to the corresponding page number 0 in the block number 8 according to the management information. The management unit 12 identifies a corresponding page number 1 in the block number 8 according to the management information, and writes the page data 2.3 to the corresponding page number 1 in the block number 8 according to the management information. The page data corresponding to a same data number may be stored in different blocks. The data with the data number 2 is stored in the block number 2, the block number 5, and the block number 8, which means that a block depth of data with the data number 2 is 3.

For example, the data with a data number 6 comprises a page data 6.0, a page data 6.2 and a page data 6.3. The management unit 12 identifies a corresponding page number 0 in the block number 10 according to the management information, and writes the page data 6.0 to the corresponding page number 0 in the block number 10 according to the management information. The management unit 12 identifies a corresponding page number 1 in the block number 10 according to the management information, and writes the page data 6.2 to the corresponding page number 1 in the block number 10 according to the management information. The management unit 12 identifies a corresponding page number 3 in the block number 10 according to the management information, and writes the page data 6.3 to the corresponding page number 3 in the block number 10 according to the management information. Since all of the data with the data number 6 is written to the block number 10, the data stored in the block number 6 becomes expired and loses its duration validity. After confirming that the data is invalid, the management unit 12 further erases the block storing the invalid data to facilitate subsequent data writing processes. Therefore, the data with the data number 6 is stored only in the block number 10, and thus has a block depth of 1.

It should be noted that, apart from sequentially writing data to corresponding pages as previously described, the management unit 12 may also write data to the corresponding pages in a non-sequential manner. For example, the data with a data number 3 comprises a page data 3.0, a page data 3.1, a page data 3.2 and a page data 3.3. For example, the management unit 12 identifies a corresponding page number 0 in the block number 3 according to the management information, and writes the page data 3.0 to the corresponding page number 0 in the block number 3 according to the management information. The management unit 12 identifies a corresponding page number 1 in the block number 3 according to the management information, and writes the page data 3.1 to the corresponding page number 1 in the block number 3 according to the management information. The management unit 12 identifies a corresponding page number 2 in the block number 3 according to the management information, and writes the page data 3.3 to the corresponding page number 1 in the block number 2 according to the management information. The management unit 12 identifies a corresponding page number 3 in the block number 3 according to the management information, and writes the page data 3.2 to the corresponding page number 3 in the block number 3 according to the management information. Thus, the management unit 12 is not limited to writing data in a sequential manner, so as to render better flexibilities in the data writing process.

When data to be written has a length greater than one block, the management unit 12 may first divide original data to block data and page data. As previously described, the block data can be written to the data storing unit 11 through the corresponding block approach, and the page data can be written to the data storing unit 11 through the corresponding page approach.

The data storing unit 11 may further comprise a merge block. When a block depth corresponding to a plurality of page data of a same data number is greater than a threshold, the management unit 12 may integrate the plurality of page data to the merge block to release more storage space.

Again referring to FIGS. 1 and 2, the page data 1.0, page data 1.0 and page data 1.1 are to be respectively written to the page numbers 0 to 2 in the block number 1 before the management unit 12 is updated. Before the update, the management unit 12 identifies the corresponding page number 0 in the block number 1 according to the management information, and writes the page data 1.0 to the corresponding page number 0 in the block number 1 according to the management information. The management unit 12 identifies the corresponding page number 1 in the block number 1 according to the management information, and writes the page data 1.0 to the corresponding page number 1 in the block number 1 according to the management information. The management unit 12 identifies the corresponding page number 2 in the block number 1 according to the management information, and writes the page data 1.1 to the corresponding page number 2 in the block number 1 according to the management information. It should be noted that, apart from being capable of writing data in a non-sequential manner (data is not necessarily written according to data numbers), the management unit 12 can also repeatedly update data of a particular data number. For example, the data with the data 1.0 is repeatedly updated to the page numbers 0 and 1 in the block number 1. Hence, an updating process of frequently used data can become easier and faster.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory device, comprising:
a data storing unit, comprising a first block comprising a first page; and
a management unit, for identifying the first page according to first management information, and writing a first page data to the first page according to the first management information, the first management information at least comprising a first block number and a first page number.

2. The memory device according to claim 1, wherein the first management information further comprises a first multi-block addressing (MBA) number representing a duration validity of the first page.

3. The memory device according to claim 1, wherein the management unit comprises:
an address management unit, for providing the first block number and the first page number; and
a management information recording unit, for recoding the first management information.

4. The memory device according to claim 1, further comprising:
a data processing unit, for generating the first page data.

5. The memory device according to claim 1, wherein the management unit further writes a second page data to the data storing unit according to second management information, and the second management information comprises a second block number and a second page number.

6. The memory device according to claim 5, wherein the first block further comprises a second page, and the management unit writes the second page data to the second page according to the second block number and the second page number.

7. The memory device according to claim 6, wherein data numbers stored in the first page and the second page are non-sequentially written to the first page and the second page.

8. The memory device according to claim 6, wherein the first page data and the second page data correspond to a same data number.

9. The memory device according to claim 5, wherein the data storing unit further comprises a second block comprising a second page, and the management unit writes the second page data to the second page according to the second block number and the second page number.

10. The memory device according to claim 9, wherein the first page data and the second page data correspond to a same data number.

11. The memory device according to claim 9, wherein the data storing unit further comprises a merge block, and the management unit integrates the first page data and the second page data to the merge block when a block depth of the second page data and the second page data is greater than a threshold.

12. The memory device according to claim 1, wherein the management unit further writes the first page data to the data storing unit according to second management information, and the second management information at least comprises a second block number and a second page number.

13. The memory device according to claim 12, wherein the first block further comprises a second page, and the management unit writes the first page data to the second page according to the second block number and the second page number.

14. The memory device according to claim 1, being a flash memory.

15. A writing method of a memory device, comprising:
identifying a first page in a first block of a data storing unit according to first management information, the first management information at least comprising a first block number and a first page number; and
writing a first page data to the first page according to the first management information.

16. The method according to claim 15, wherein the first management information further comprises a first MBA number representing a duration validity of the first page.

17. The method according to claim 15, further comprising:
writing a second page data to the data storing unit according to second management information, the second management information at least comprising a second block number and a second page number.

18. The method according to claim 17, wherein the writing step is writing the second page data to a second page in the first block according to the second block number and the second page number.

19. The method according to claim 19, wherein data numbers stored in the first page and the second page are non-sequentially written to the first page and the second page.

20. The method according to claim 18, wherein the first page data and the second page data correspond to a same data number.

21. The method according to claim 19, wherein the writing step is writing the second page data to a second page in a second block of the data storing unit according to the second block number and the second page number.

22. The method according to claim 21, wherein the first page data and the second page data correspond to a same data number.

23. The method according to claim 22, further comprising:
integrating the first page data and the second page data to a merge block of the data storing unit when a block depth corresponding to the first page data and the second page data is greater than a threshold.

24. The method according to claim 16, further comprising:
writing the first page data to the data storing unit according to second management information, the second management information at least comprising a second block number and a second page number.

25. The method according to claim 24, wherein the writing step is writing the first page data to a second page in the first block according to the second block number and the second page number.

26. A memory device, comprising:
a data storing unit, comprising a plurality of physical blocks each comprising a plurality of pages; and
a management unit, for writing a first page data to a page in a first physical block of the data storing unit, and writing a second page data to a page in a second physical block of the data storing unit, the first page data and the second page data corresponding to a same first logical block number.

27. The memory device according to claim 26, wherein the management unit further writes a third page data to a first page in a third physical block of the data storing unit, and writing a fourth page data to a second page in the third physical block, the third page data and the fourth page data corresponding to a same second logical block number.
